(19) United States
(12) Patent Application Publication
(10) Pub. No.: US 2004/0095471 A1
(43) Pub. Date: May 20, 2004

(54) Telescopic system with imaging function

(75) Inventor: Christof Heintz, Oberursel (DE)

Correspondence Address: WELLS ST. JOHN P.S., 601 W. FIRST AVENUE, SUITE 1300, SPOKANE, WA, 99201, US

(73) Assignee: Hensoldt AG

(21) Appl. No.: 10/672,334

(22) Filed: Sep. 25, 2003

(30) Foreign Application Priority Data
Sep. 28, 2002 (DE) 102 45 395.0

(51) Int. Cl. H04N 5/225

(52) U.S. Cl. 348/207.99

(57) ABSTRACT

The telescopic system with imaging function comprises at least one tube having a beam path through an objective and an eyepiece. Furthermore, the telescopic system has a device for coupling out a partial light beam. A module with an image sensor for converting images into digital data is fitted to a housing of the tube which contains the device for coupling out the partial light beam in such a way that it is possible to couple out an optical signal on the image sensor. A completely autonomous digital camera with an interface for an additional external image sensor is likewise present.

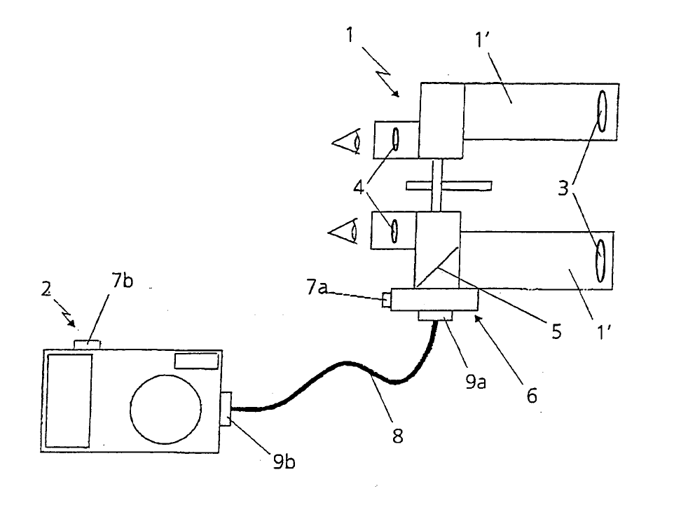

### BACKGROUND OF THE INVENTION

1. Field of the Invention

The invention relates to a telescopic system with imaging function.

2. Description of the Related Art

Generally known telescopic system serve for the observation of objects by an observer. Telescopic systems which are able to record a viewed image through a telescopic system have been known for some time.

By way of example, JP 11064740 shows binoculars with a recording and reproduction device. The binoculars have a construction in which a beam splitter cube is arranged in a beam path in order to couple out a partial light beam, the coupled-out partial light beam being passed to an imaging system in order to generate an image there within the binoculars. What is disadvantageous about this construction is that a digital camera is integrated directly in the binoculars and, consequently, the binoculars have a disadvantageously high weight.

U.S. Pat. No. 5,963,369 describes a stereoscopic image system connected to traditional binoculars. Each tube contains a beam splitter which is arranged between an objective and an eyepiece for the purpose of splitting the incoming light. Furthermore, an image sensor arranged outside the beam path is used. Said image sensor converts the images into an electronic signal. A signal receiver, which is likewise arranged outside the beam path, converts the electronic signals into images. A storage unit is likewise present, which stores the recorded signals in order that the observer can view the images, with stereopsis, for example on a PC monitor with the aid of polarizing spectacles.

If pictures can be stored internally, much electronics must be contained in the binoculars (select image sensor, work on data, data compress; batteries; memory unit). That makes the binoculars also heavy and voluminous. Furthermore, special storage units have to be present for holding the data.

DE 101 15 854 A1 likewise discloses binoculars with an imaging function. The binoculars contain optical observation systems for viewing an object and a separate optical channel with an imaging device for recording an image. Furthermore, the binoculars comprise a photoelectric transducer unit for converting an image received from the separate optical imaging system into an electrical signal. These binoculars need a complete digital camera within the binoculars, which makes the binoculars heavier and more voluminous.

### SUMMARY OF THE INVENTION

Accordingly, it is an object of the invention to provide a telescopic system with an imaging function which solve the disadvantages of the prior art, in particular enable a digital recording of an image seen through the telescopic system by means of the coupling out of an optical signal and enable the recorded image to be viewed near that time, the intention being to achieve a low weight for the telescopic system.

This object is achieved according to the invention by means of telescopic system with imaging function, comprising:

at least one tube comprising a beam path through an objective and an eyepiece;

a device for coupling out a partial light beam;

a module with an image sensor for converting images into digital data, which is fitted to a housing of the tube which contains the device for coupling out the partial light beam in such a way that it is possible to couple out an optical signal on the image sensor;

a completely autonomous digital camera with an interface for an additional external image sensor.

The telescopic system, in addition to comprising the customary optical components such as objective, eyepiece and prism system for image erecting, likewise comprise a device for coupling out a partial light beam, the device advantageously being able to be formed as a beam splitter cube or as a splitter mirror. A partial light beam is coupled out according to the coupling-out method described in JP 11064740, the coupling-out device being arranged between the objective and the eyepiece. The partial light beam coupled out in the beam splitter cube impinges on the image sensor of the module. The module then converts the images into digital data, the data advantageously being transmitted via a cable into the digital camera.

The essential advantage of the embodiment of these telescopic system is that a conventional digital camera which corresponds to the prior art and has an interface for a second image sensor can be used for the recording, reviewing and handling images. The digital camera is an independent camera which can carry out recordings of an image even without a connection to the telescopic system. The relatively low additional weight of the module on the telescopic system means that it is possible to realize light and compact telescopic system.

Advantageous refinements and developments emerge from the subclaims and the exemplary embodiment which is described in principle with reference to the drawing.

### BRIEF DESCRIPTION OF THE DRAWING

The drawing shows a telescopic system 1 and a digital camera 2, only the parts or elements that are most important for the invention being identified.

### DETAILED DESCRIPTION

In the present embodiment, the telescopic system 1 is represented in binocular execution. A monocular execution of the telescopic system would be just as possible.

The telescopic system 1 comprises in each case two optical systems, each system comprising an objective 3, an eyepiece 4, a prism system for image erecting, which is not illustrated, and a device 5 for coupling out a partial light beam. The partial light beam can be coupled out according to the method described in JP 11064740 or in U.S. Pat. No. 5,963,369. A module 6 with an image sensor (not illustrated) is fitted to an outer side of the teles-copic system 1. The module 6 is furthermore provided with a release button 7a. The module 6 is connected to the digital camera 2 via a cable 8. A release button 7b is likewise situated on the digital camera 2.

The module 6 additionally comprises a mechanical shutter which functions as shutter and as shutter aperture setting (not illustrated here). Furthermore, lenses are integrated in the module 6 in order to achieve adaptation of the image field to the size of the chip and to ensure manual synchronous focusing of the image on the image sensor (not illustrated). An electronic unit is additionally provided, which interrogates the release button 7a and the image sensor integrated in the module 6, regulates the exposure time, operates the shutter and sends the digital image signal to the digital camera 2. A cable 8 is available for data transmission. Various digital interface/transmission technologies, such as RS 232, USB, IEC 1394 are available for the transmission of the data, the USB bus system being used in the present exemplary embodiment. It would also be possible to use diverse wireless technologies such as, for example, Bluetooth or IEC 802.1 lb. The cable 8 contains cores for transmitting the digital image signal and simultaneously serves as the voltage supply of the module 6. Two separate cables could also be provided for this purpose in a further exemplary embodiment. As an alternative, the module 6 could also be operated with its own battery.

Since the module 6 is fixed in a relatively small and compact fashion on the housing of the telescopic system 1, the telescopic system remain light and compact.

The module 6 is embodied such that it can be exchanged or detached for repair purposes or to be equipped with better image sensors.

The module 6 and the digital camera 2 have connections 9a and 9b.

During the observation or for the recording of an image, the cable 8 is inserted into the connections 9a and 9b of the module 6 and the digital camera 2. In an advantageous manner, the digital camera 2 then switches over automatically to the external sensor 6. It is furthermore possible to switch over between the image sensors via a menu selection of the digital camera 2.

A motorized autofocus is not provided for the representation of the image in this exemplary embodiment. However, it may, of course, be integrated into the module 6. Furthermore, the exemplary embodiment is based on a mechanical displacement of the optical elements of the telescopic system 1 in front of the image sensor in the module 6 which is effected synchronously with the focusing of the telescopic system 1 by the user.

The evaluation of the image sensor 6 is carried out by the electronic unit provided for the internal image sensor of the digital camera 2. Consequently, all possibilities which are carried out nowadays with digital cameras are open, in particular still images, serial images, videos or similar recordings.

For sound recordings, it would be possible to integrate a microphone in the module 6 in another exemplary embodiment.

What is claimed is:

1. Telescopic system with imaging function, comprising:
at least one tube comprising a beam path through an objective and an eyepiece;
a device for coupling out a partial light beam;
a module with an image sensor for converting images into digital data, which is fitted to a housing of the tube which contains said device for coupling out said partial light beam in such a way that it is possible to couple out an optical signal on said image sensor;
an autonomous digital camera with an interface for an additional external image sensor.

2. The telescopic system with imaging function as claimed in claim 1, wherein said module is connected to said interface of the digital camera via a cable.

3. The telescopic system with imaging function as claimed in claim 2, wherein the digital image information can be transmitted via said cable.

4. The telescopic system with imaging function as claimed in claim 1, wherein the digital image information can be transmitted wireless.

5. The telescopic system with imaging function as claimed in claim 1, wherein said device for coupling out said partial light beam is a beam splitter cube.

6. The telescopic system with imaging function as claimed in claim 1, wherein said device for coupling out said partial light beam is a splitter mirror.

7. The telescopic system with imaging function as claimed in claim 1, wherein said interface is a USB-interface.

8. The telescopic system with imaging function is claimed in claim 1, wherein said interface is an RS 232-interface.

9. The telescopic system with imaging function as claimed in claim 1, wherein said interface is an IEC 1394-interface.

10. The telescopic system with imaging function as claimed in claim 2, wherein the voltage supply is provided via said cable.
